(19) United States
(12) Patent Application Publication
(10) Pub. No.: US 2014/0087116 A1
(43) Pub. Date: Mar. 27, 2014

(54) HIGH-SPEED MASKING TAPE APPARATUS AND METHOD

(71) Applicant: Christopher D. GLATT, Burnsville, MN (US)

(72) Inventor: Christopher D. GLATT, Burnsville, MN (US)

(21) Appl. No.: 14/096,933

(22) Filed: Dec. 4, 2013

Related U.S. Application Data
(63) Continuation-in-part of application No. 13/136,704, filed on Aug. 8, 2011.
(60) Provisional application No. 61/377,568, filed on Aug. 27, 2010.

(51) Int. Cl. C09J 7/02; B65H 37/02

(52) U.S. Cl. CPC C09J 7/02; B65H 37/02
USPC 428/80; 428/195.1; 428/141

(57) ABSTRACT

An elongated masking tape strip includes a flexible backing and an adhesive placed on a portion of the flexible backing. The flexible backing has a first long side, a second long side, a third short side, and a fourth short side. The adhesive placed on a portion of the flexible backing forms a first area including an adhesive and a second area that is adhesive free. The adhesive portion includes at least substantially one of the first long side and a second long side. The tape strip can be stacked with other tape strips to form a dispensing device.

### CROSS-REFERENCE TO RELATED APPLICATIONS

This application is a continuation-in-part application of U.S. patent application Ser. No. 13/136,704 filed on Aug. 8, 2011, which claims the benefit that application and also claims the benefit of provisional patent application No. 61/377,568 filed Aug. 27, 2010, and which applications are incorporated herein by reference.

### TECHNICAL FIELD

The present invention relates to a high-speed masking tape or painters' tape dispensing device that includes stacked strips of adhesive tape.

### BACKGROUND OF THE INVENTION

Masking tapes are commonly used in painting and refinishing operations. Such operations include painting or sealing a surface, as well as sanding or otherwise preparing the surface for painting. Currently, masking of painters' tape is manufactured in rolls. The user finds the end of the tape and then pulls off a length and uses the length obtained to mask off an area near an area that will be painted. The masking tape prevents paint from being applied to the masked area.

Rolls of masking tape or painters' tape frustrate users. Users have difficulty trying to get a piece of tape started off a traditional roll of tape, because the adhesive covers the entire width of the tape. The user has to pick or scrape at the roll with a fingernail, knife, razorblade, or other thin device in order to get the piece of tape started off the roll.

Once the piece of tape is released from the roll or started, the frustration has just begun. The traditional roll of tape is one long piece of tape wound convolutedly upon itself. The user has to unroll a desired length and then either tear or cut the masking tape while attempting to keep the tape from sticking to itself. This can get tricky with longer lengths of tape. Some users tear the tape by hand, which many times is imprecise. Some users cut the tape using some sort of tool such as a scissors or knife. Keeping the tape straight while trying to cut the tape complicates the process of obtaining tape of a certain length from a roll. The end result is that many times the tape is not of the right length. The user then has to cut or tear another piece of tape to cover a remaining length. Thus, each edge to be masked requires two lengths of tape. This is time-consuming, inefficient and frustrating for the user. Thus, the roll of tape seems to have many problems. Some of the problems become particularly evident when taping off window panes. Old-fashioned double hung windows can have as many as 12-16 individual panes. Each edge of each pane in a window typically requires two pieces of tape. A single window with sixteen panes would require the user to tear off 128 separate pieces of tape in order to effectively mask off the panes of glass so that the supports between the panes and the edges of the window can be painted. That is two pieces of tape for each side of the pane which amounts to eight pieces of tape for each pane. Multiplying this by 16 panes yields 128 pieces of tape. Many times a paint job includes multiple windows.

Another problem is that once the tape is ripped by hand, the resultant edge is jagged, sloppy, and inconsistent. Wicking of the paint can occur along the jagged edge. Additionally, the jagged edge may not appeal to the inherent desire for neatness present in many painters and/or do-it-yourselfers.

Window panes require relatively short pieces of tape. More difficulty is encountered when long pieces of tape are required. Longer pieces of tape are required along baseboards, ceiling edges and the like. Other applications might be in a corner where the paint color will switch. Still further applications occur that are outside of painting a room. When the tape is long, the tape tends to curl back upon itself after it has been unrolled from the roll. In other words, when a piece of any significant length is ripped off it tends sticks to itself. Generally, the user balls up the tape and throws it away. In some instances, a portion of the tape is saved and the stuck on itself portion is discarded.

Additional frustration presents itself when the user tries to remove tape after painting is complete. Again, it is difficult to get a fingernail, knife, razorblade, or other thin device under the edge of the tape to begin removing it from the wall, trim, window pane, vehicle or whatever else the user happens to be painting.

Additional shortcomings are inherent in the cardboard roll upon which traditional masking tape is wound. The roll has a hollow area in its center which is essentially wasted space. When packaged, shipped, or displayed on a shelf, this hollow area of wasted space results in additional bulk, leading to extra shipping, packaging, inventory, and warehousing costs. The cardboard roll is generally thrown into the trash as waste.

One method of manufacturing tape is disclosed in U.S. Pat. No. 5,654,055 granted Aug. 5, 1997. According to this disclosure, the tape is manufactured with a stiffened edge to facilitate insertion under moldings or gaskets in order to refinish underneath at least a portion of the molding or gasket. The problem with this approach is that the stiffened portion is unnecessary and obtrusive for the majority of painting operations which do not require paint underneath whatever is being masked off. Additionally, this approach does not facilitate easy removal of individual pieces of tape from the roll. Each piece still needs to be individually cut or ripped off of the roll.

Another method of manufacturing a substrate with adhesive applied to only a portion of the surface is disclosed in U.S. patent for 3-M's Post It Notes. This approach comprises a stack of sheets of substrate with adhesive applied to only a longitudinal portion of the substrate. The problem with this approach is that the size and shape of the substrate is not conducive to masking off areas for painting. Additionally, the adhesive is not formulated for the prevention of paint working its way underneath the substrate. Instead, the adhesive is designed to adhere lightly to a surface in anticipation of its later removal. It is basically used for the temporary display of handwritten notes. Also, the composition of the substrate is not of a stiffness ideal for masking off areas for painting. Basically, the product described in the Post It Note patent is designed for an entirely different purpose totally dissimilar from masking off areas for painting.

### SUMMARY

The present invention relates to a masking tape or painters' tape for use during preparation, sanding, painting, and/or refinishing operations. This tape is used for masking off areas not to be refinished or painted such as moldings, trim, window-pane dividers, walls, vehicles or anything else needing painting or refinishing. More particularly, the present invention relates to a tape structure and resulting device for use in masking such moldings, trim, window-panes, walls, vehicles, and the like which effectively protects the masked area while permitting refinishing or painting of the area immediately adjacent thereto.

A masking tape dispensing apparatus includes a substrate and a normally tacky pressure-sensitive adhesive. The tape is manufactured in stacked elongate strips instead of on a cardboard roll. The strips generally have adhesive, however two longitudinally opposed corners of each strip are adhesive free. The corners are on the same side of the stripe of tape. When used, these two corners are oriented away from the edge used to mask the horizontally.

Manufacturing the tape in strips allows the user to avoid having to cut or tear individual pieces of tape off of a roll of tape. The strips in the present invention are already cut to a convenient length. All the user has to do is grasp the top strip and remove it from the stack. It can then be placed on the area to be masked off. Leaving adhesive off of two corners of the strip allows the user to more easily grasp the corner of the strip to take it off the stack. The user does not have to get a finger nail, knife, or other tool under the top piece of tape to get it started off the stack. The two non-adhesive corners are indicated by a different color, or a different shade of color, to clearly indicate where the user should grasp the top strip of tape.

Additionally, once painting is complete, said non-adhesive portions also allow easier removal of the tape from the surface that was painted. Again, the user does not have to work a fingernail or other tool under the edge of the tape to get it started off of the painted surface. The present invention also omits the wasteful and bulky cardboard roll. This saves shelf space, inventory costs, and shipping costs.

### DRAWINGS

The embodiments will be readily understood by the following detailed description in conjunction with the accompanying drawings, wherein like reference numerals designate like structural elements, and in which:

FIG. 1 shows a top view of stack of tape strips with straight ends and adhesive left off angled portions of the top longitudinally opposed ends, according to an example embodiment.

FIG. 2 shows a top view of stack of tape strips with angled ends and adhesive left off angled portions of the top longitudinally opposed end, according to an example embodiment.

FIG. 3 shows a top view of stack of tape strips with straight ends and adhesive left off a longitudinal area of the tape running the entire length of the tape, according to an example embodiment.

FIG. 4 shows a top view of stack of tape strips with angled ends and adhesive left off a longitudinal area of the tape running the entire length of the tape, according to an example embodiment.

FIG. 5 shows how a stack of strips can be cut in one slice to customize the length convenient to the job at hand, according to an example embodiment.

FIG. 6 shows how the smaller, user-customized strips could then be applied to a window pane, according to an example embodiment.

FIG. 7 shows a front view of an individual strip that includes a backing material portion carrying an adhesive portion, according to an example embodiment.

FIG. 8 is a schematic that shows the aspect ratio of the tape strips, according to an example embodiment.

### DETAILED DESCRIPTION

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

### DEFINITIONS

The specification includes terms that are defined below.

The term painting as used throughout this specification is meant to include the application of paints, lacquers, varnishes, or other similar substances by spraying, brushing, using a roller, and other similar treatments to include the application of any substance to a surface of which part of the surface is to be treated, while an adjacent part is masked from treatment. The term painting is also meant to include refinishing.

The term refinishing is defined as treating a surface which has been previously painted and then stripped or sanded in preparation for a new application of paint, lacquer, varnish or other similar treatment.

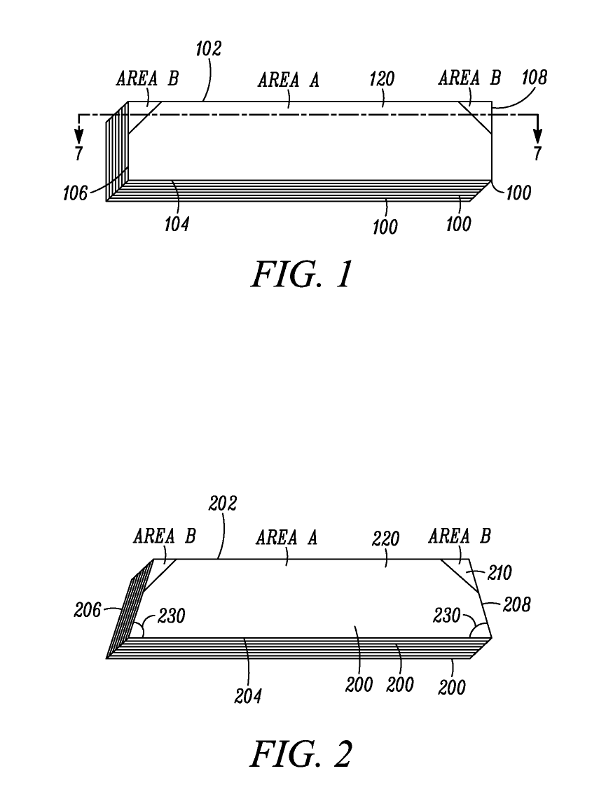

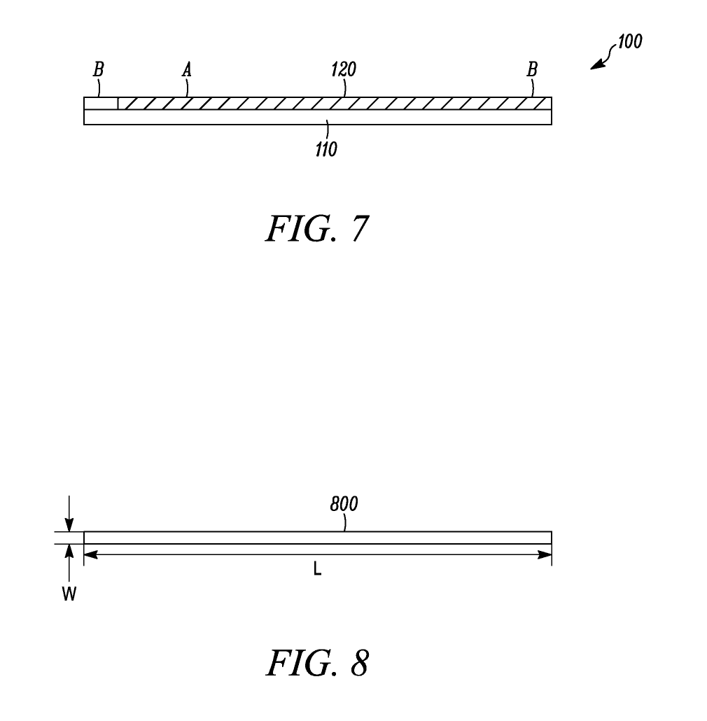

The present invention provides a pressure-sensitive adhesive tape that is useful as a general-purpose masking tape. FIG. 7 shows a front view of an individual strip 100 which includes a backing material portion 110 that carries an adhesive portion 120. Each individual tape strip 100 is made of a backing material with adhesive covering 120 placed at least a portion of the backing material 110. The backing material also has an area substantially free of adhesive, designated by the letter B. Put another way, the backing material has areas where adhesive is not applied to certain portions of the backing material 110. These non-adhesive portions are all indicated in areas designated by the letter “B” of FIGS. 1 through 4. The backing material 110 and the adhesive 120 are bonded together using normal methods and products for masking tape or painters' tape, with the exception that the adhesive portion 120 only covers a certain portion of the backing material 110, as shown in FIGS. 1-4.

FIG. 1 shows a stack of tape strips with straight ends, according to an example embodiment. Area A is the area with adhesive 120. Area B would be the area where adhesive has not been applied or the area substantially free of adhesive. In one embodiment, areas A and B would be differentiated in color. This would allow the user to differentiate the adhesive carrying portion of the strip 100 from the adhesive free area B of the strip 100. In another embodiment, the adhesive 120 applied has a distinctive color that differs from the color of the backing 110. In another embodiment, the backing 110 may have a different texture in areas where the adhesive 120 has been applied (area A) as opposed to adhesive free areas (area B). The adhesive may react with the backing to change the texture. In still another embodiment, the boundary between the adhesive area A and adhesive free area B can be marked. The marks may be approximations but will provide a visual indication of the area A and area B. It is also thought that the marked area could include the term “adhesive free” or the like. Again, this allows the user to quickly identify the portions of the strip 100 that carry adhesive 120 from those areas B of the strip 100 which are substantially free of adhesive. This indicator helps the user to correctly position the tape during use. In other words, when applying the strip to mask an area, the area B portions are placed away from the edge of the material to be masked. The strip 100 is essentially rectangular-shaped. The strip 100 has elongated sides 102, 104 and shortened sides 106, 108. The shortened sides 106, 108 substantially form a right angle with the elongated sides 102, 104.

FIG. 2 shows a stack of tape strips 200 with angled ends 206, 208, according to an example embodiment. Each strip 200 includes a backing portion 210 and an adhesive carrying portion 220. Area A on the backing 210 is the area with adhesive 220. Area B is the area where adhesive has NOT been applied. Area B is, therefore, substantially free of adhesive. The areas A and B would be differentiated in color, in one embodiment. In another embodiment, the adhesive 220 would be a different color than the backing 210. In other words, there would be some sort of indication differentiating the adhesive free areas, such as area B, from the adhesive carrying areas, such as area A. The strip 100 is shaped like a trapezoid. The strip 100 has elongated sides 202, 204 and shortened sides 206, 208. The shortened sides 206, 208 form an acute angle 230 (not a right angle) with the elongated sides 202, 204. Elongated side 202 is shorter than elongated side 204. The two areas that are substantially free of adhesive are along the shorter side 202. The longer side 204 can be used for masking an area not to be painted which will be adjacent an area to be painted. The strip 200 and more specifically the portion near and at the ends 206, 208 can be placed into a corner. In one embodiment, the acute angle 230 is more than 45 degrees and less than 90 degrees. In this way, two strips 200 will overlap slightly when placed into a corner that forms a right angle (shown in FIG. 6).

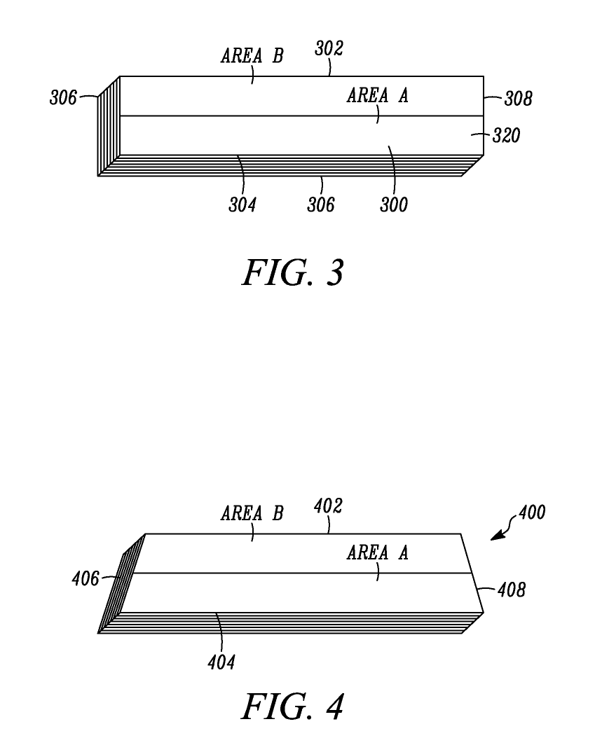

FIG. 3 shows a stack of tape strips 300 with an elongated adhesive portion depicted by area A, and an elongated adhesive free portion, depicted by area B, according to an example embodiment. In area B, the adhesive is left off substantially the entire length of the strip 300. This forms a longitudinal area of the strip B which runs the entire length of the strip 300. Each strip 300 includes an elongated side 302, an elongated side 304, a short side 306 and a short side 308. The short sides 306, 308 form substantially a right angle with respect to the elongated sides 302, 304. FIG. 3 shows a stack of tape strips 300 with straight ends. Again, area A would be the area with adhesive 320, and area B would be the area where adhesive has NOT been applied. Areas A and B could be differentiated in some way, such as by color, texture, or otherwise.

FIG. 4 shows a stack of tape strips 400 with an elongated adhesive portion depicted by area A, and an elongated adhesive free portion, depicted by area B, according to an example embodiment. The stack of tape strips 300 (shown in FIG. 3) is similar to the stack of tape strips 400. For the sake of brevity, only the major differences between the embodiments will be discussed. Each tape strip 400 has an elongated side 402, an elongated side 404, a short side 406 and a short side 408. The short sides 406, 408 form substantially an acute angle with respect to the elongated side 404. The main difference is that the tape strips 400 are trapezoidally-shaped with elongated side 404 being longer than elongated side 402. Areas A and B are differentiated.

FIG. 6 shows how the smaller, user-customized strips could then be applied to a window pane, according to an example embodiment. Strip C was the first strip applied, followed by strip D.

The height of the stack of tape strips 100, 200, 300, 400 would likely be, but is not limited to, a range of one-third of an inch and two inches. The length and width of each strip of tape is also not specific to allow for application of the invention to many different areas of use. Short strips might be advantageous when taping off a window pane, or longer strips might be preferred when taping off a long piece of base-board trim or molding. The width would also be variable and customized to whatever the manufacturer wants, or whatever the consumer desires. In addition, the width of the tape strips 100, 200, 300, 400 is not limited and can be sold in different widths for different applications.

The substrate and adhesive used would likely be, but are not limited to, substrates and adhesives presently and traditionally used in the manufacture of masking tape or painters' tape. Different adhesives could be used, and different substrates could be used. For example, the substrate could be made more or less stiff or more or less rigid than the substrate in traditional painters' tape to allow for easier manipulation of the tape. This variable stiffness would be feasible due to the fact that the tape does not have to be wound around a roll.

One embodiment involves leaving adhesive off a longitudinal area of the tape running the entire length of the tape. This would allow the user to cut many strips of tape to a convenient length with one slice. Advantageously, no matter the length to which the stack is cut, there will still have a non-adhesive portion (area B) to grasp for ease in removing the piece of tape from the stack and for ease in removing the tape strip from the position in which it was placed for masking an area. This embodiment is shown in FIGS. 3 and 4.

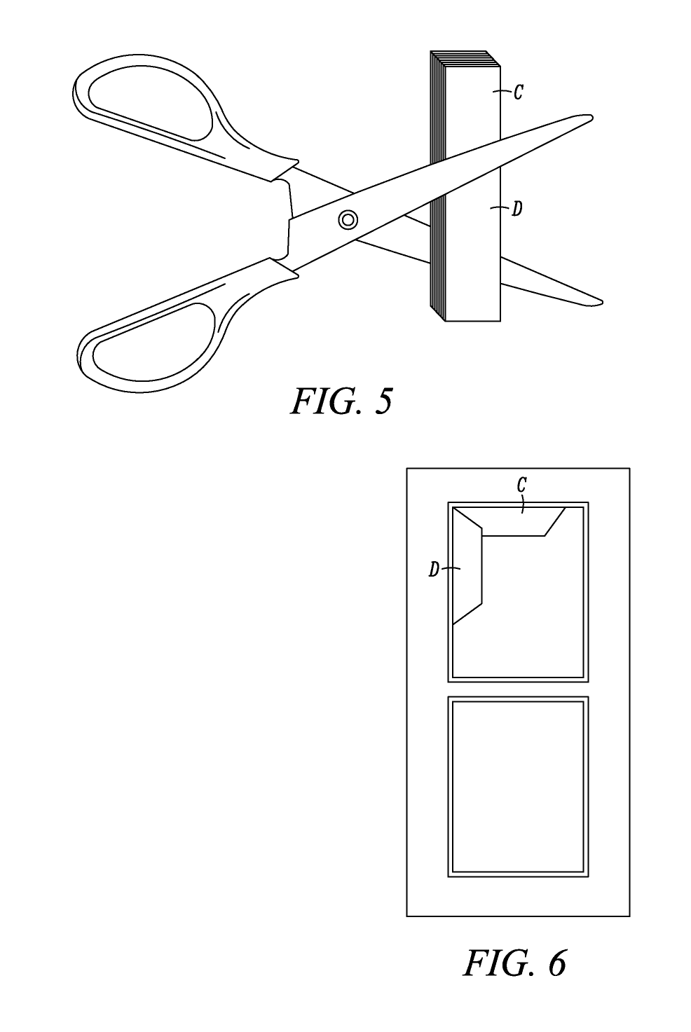

FIG. 5 shows a stack of strips being cut in one slice to customize the length of all the tape strips in the stack, according to an example embodiment. FIG. 5 shows how a stack of strips can be cut in one slice to customize the length convenient to the job at hand. Such a job might be taping off a window pane. A cut, depicted by the dashed line, is angled with respect to the elongated sides of the stack of strips. This cut results in a stack of strips C having a first length and a stack of strips D having a second length. The lengths of strips C and D can be the substantially the same or different.

FIG. 6 shows how the smaller, user-customized strips C, D could then be applied to a window pane. Because adhesive has been omitted along a portion running the entire length of the strip, there is always a non-adhesive portion to grasp no matter what length the strips are cut to. In other words, one of the long sides of the tape strip is substantially free of adhesive. Therefore, no matter where the cut is made, there is always a non-adhesive portion to grasp along the adhesive free side of the tape strip.

Another embodiment is to manufacture the strips in shorter lengths specifically for the purpose of taping off window panes or other jobs needing shorter strips. The short ends of the tape could be precut at angles for easy application in the corner of window panes as shown in FIG. 6. This would prevent the user from having to customize the length of the strips, since they would already be precut.

Another embodiment would be to not differentiate the color of the non-adhesive portions of the tape. Said embodiment would be useful if the process of differentiating the color of the non-adhesive area proves to be too costly or difficult.

Another embodiment would be to differentiate the texture of the non-adhesive portion of the tape. A different texture would give said portion of the tape a different feel as well as a different appearance. This differentiation would allow the user to identify where to grasp the non-adhesive portion of the tape by feel as well as appearance.

Another embodiment would be to place a stiffer medium, such as cardboard, under the stack of strips. This would reduce the flimsiness that might be present in a stack of tape strips absent a backing material. This embodiment is similar to the idea of having a stiff piece of cardboard at the bottom of a pad of paper. Some of the stiffness of the cardboard is then imparted to the entire stack of strips.

FIG. 8 is an illustration that shows the aspect ratio of the tape strips, according to an example embodiment. Shorter tape strips are illustrated in FIGS. 1-6 and the example embodiments described thus far discuss taping window panes. Also discussed are masking longer items including base boards, ceiling and wall interfaces, car trim, door trim and the like. FIG. 8 shows a longer version of the tape strips 800. In all cases the tape strips have a width, W, and a length L. The tape for a longer version can be about 1″ to 3″ wide, and has a length in the range of 4 feet to 7 feet. The aspect ratio of a 1″ wide tape that is 4 feet long is 1:48. If the tape is 3″ wide, the aspect ratio is 1:16. The aspect ratio of a tape that is 1″ wide and 7 feet long is 1:84. If the tape is 3″ wide the aspect ratio of a 7 foot tape is 1:28. Therefore, the range of aspect ratios of longer tape strips is from 1:25 to 1:95. In one embodiment, the range of aspect ratios of the longer tape strips is 1:16 to 1:84.

Shorter strips have aspect ratios of 1:4 to 1:18 in one embodiment. In other embodiments, the tape strips have an aspect ratio of 1:5 to 1:16. Of course, the aspect ratios will vary when the width of the tape used to make the strip changes. The width of the tape will be in the range of ½ inch to about 2 inches. The length of the tape strip can be anywhere from 3″ to 96″. Therefore, the aspect ratio will range from 1:6 to 1:192 for most tape strips.

It should be noted that in some embodiments, the adhesive portion can cover less than half of the backing material. In other words, area A could be well less than the area B (adhesive free area). So, a relatively thin strip of adhesive could be placed along the edge of the backing material. In other embodiments, only a thin strip of adhesive free area is included as area B.

### Operation

When painting a surface, this invention speeds up the process of masking off areas where it is NOT desired to apply paint, lacquer, stain, varnish or similar products, using masking tape.

The presently described invention omits adhesive from a portion of the tape as shown in FIGS. 1 through 4. Operation is as follows. First, the user visually identifies the color-differentiated portion of the strips. In other embodiments, the adhesive free area can be visually identified by another indicator, such as tape texture, or even printed marking on the tape strip. The top strip is then grasped at the substantially adhesive free portion, area A, which may be a color-differentiated portion. The strip 100, 200, 300, 400 is removed from the stack of strips 100, 200, 300, 400. The removed strip 100, 200, 300, 400 is then placed on the area where paint, lacquer, etc. is not to be applied. The invention omits the need for scraping and picking at the edge of the tape to get it started from the roll in favor of simply grasping the non-adhesive portion or adhesive free area (area B) of the tape to start it off the stack of tape strips 100, 200, 300, 400. After painting is complete, the user simply grasps the easily-identifiable, non-adhesive portion for quick removal of the tape strip from the object being painted.

A stack of shorter strips 100, 200, 300, 400 would be ideal for taping off window panes. Using the traditional roll of tape, taping off window panes is labor-intensive because so many strips need to be ripped or cut off the roll. To overcome this, the user cuts a number of strips at one time using a scissors or other cutting tool as shown in FIG. 5. The length of the cut is whatever the user feels is convenient to the job at hand. The strips are then placed on the window pane as shown in FIG. 6. FIG. 6 shows how the strips C, D with angled ends can effectively mask off each corner of the window pane. Alternatively, if the manufacturer precut and packaged these shorter strips for sale in advance, the user could use the strips straight out of the package, with no additional cutting necessary.

The length of the tape strips can be varied. FIG. 8 shows a long strip that is useful for masking off trim around a door, baseboards, ceilings, and the like. The length of the tape strip 800 generally must be something the user can handle and which can be handled and transported to retail outlets. Generally, a balance is made as the longer the strip the less number of tape strips needed to finish a job that requires masking a long length of material not to be painted. The longer strips also require less number of joints to be formed. This is balanced by what can be stocked on a store shelf or what can be easily handled and transported without damage by the consumer. It is thought that there could be lengths for consumers and longer lengths for professionals.

The invention as described has many advantages. Among the advantages are one or more of the following:
a) Users will find it easy to initially remove tape for initial application to a surface;
b) The color-marked corners will clearly indicate where the user should grasp the strip of tape to remove it from the stack;
c) Each piece of tape will not have to be ripped or cut since the strips are already cut to a convenient length;
d) Edges of tape will be neat and clean instead of jagged and sloppy;
e) Tape will resist the tendency to curl back upon itself;
f) Tape will be easier to remove after painting is complete;
g) Less space will be needed for shipping, warehousing, and display of tape; and
h) Less time will be needed to tape a room or a job and less time will be needed to remove the tape strips after the painting is done.
   Of course, the above list is not exhaustive. There are other advantages that may be realized and that are not described herein.

An elongated masking tape strip includes a flexible backing and an adhesive placed on a portion of the flexible backing. The flexible backing has a first long side, a second long side, a third short side, and a fourth short side. The adhesive placed on a portion of the flexible backing forms a first area including an adhesive and a second area that is adhesive free. The adhesive portion includes at least substantially one of the first long side and a second long side. In one embodiment, the ratio of a third side to the first side is in the range of 1:18 to 1:192. In other embodiments, the ratio of a third side to the first side being in the range of 1:20 to 1:150. In still another embodiment, the ratio of a third side to the first side being in the range of 1:25 to 1:101. In still another embodiment, the ratio of a third side to the first side being in the range of 1:30 to 1:84. In still another embodiment, the second area includes a first corner and a second corner on the other of the first long side and a second long side. In yet another embodiment, the second area includes substantially the entire length the other of the first long side and a second long side. The flexible backing includes a visual indicator that indicates one of at least first area or the second area. The visual indicator can be printing on the flexible backing or printing carried by the adhesive. The visual indicator can be a color printed on the flexible backing or a color carried by the adhesive. In another embodiment, the flexible backing includes a tactile indicator that indicates one of at least first area or the second area. The tactile indicator can be a texture associated with one of at least first area or the second area. In one embodiment, the first long side and the second long side are different lengths. Therefore, the short ends are angled with respect to the first and second long sides. In another embodiment, the first long side and the second long side are substantially equal in length and wherein the third side and the fourth side are substantially equal in length, the first long side and the second long side having a length that is different from the length of the third side and the fourth side.

A dispensing apparatus for dispensing strips of masking material includes a first tape strip, and a second tape strip stacked onto the first tape strip. The first tape strip and the second tape strip further also include a flexible backing and an adhesive placed on a portion of the flexible backing. The flexible backing further includes a first long side, a second long side, a third short side, and a fourth short side. The adhesive is placed on a portion of the flexible backing to form a first area including an adhesive and a second area that is adhesive free. The adhesive portion includes at least one of the first long side and a second long side. The ratio of a third side to the first side being in the range of 1:18 to 1:192, in one embodiment. In other embodiments, the ratio of a third side to the first side being in the range of 1:20 to 1:150. In still another embodiment, the ratio of a third side to the first side being in the range of 1:25 to 1:101. In still another embodiment, the ratio of a third side to the first side being in the range of 1:30 to 1:84. In still another embodiment, the second area includes a first corner and a second corner on the other of the first long side and a second long side. In yet another embodiment, the second area includes substantially the entire length the other of the first long side and a second long side. The flexible backing includes a visual indicator that indicates one of at least first area or the second area. The visual indicator can be printing on the flexible backing or printing carried by the adhesive. The visual indicator can be a color printed on the flexible backing or a color carried by the adhesive. In another embodiment, the flexible backing includes a tactile indicator that indicates one of at least first area or the second area. The tactile indicator can be a texture associated with one of at least first area or the second area. In one embodiment, the first long side and the second long side are different lengths. Therefore, the short ends are angled with respect to the first and second long sides. In another embodiment, the first long side and the second long side are substantially equal in length and wherein the third side and the fourth side are substantially equal in length, the first long side and the second long side having a length that is different from the length of the third side and the fourth side.

In one embodiment, the first tape strip and the second tape strip are included in a stack of strips. In one embodiment the stack of strips has a thickness in the range from 0.10 to 3.0 inches. In another embodiment, the stack of strips has a thickness in the range from 0.25 to 2.5 inches. In yet another embodiment, the stack of strips has a thickness in the range from 0.35 to 2.1 inches. The dispensing apparatus having the stack of strips includes a stiffening member associated with the stack of strips.

This has been a detailed description of some exemplary embodiments of the invention(s) contained within the disclosed subject matter. Such invention(s) may be referred to, individually and/or collectively, herein by the term “invention” merely for convenience and without intending to limit the scope of this application to any single invention or inventive concept if more than one is in fact disclosed. The detailed description refers to the accompanying drawings that form a part hereof and which shows by way of illustration, but not of limitation, some specific embodiments of the invention, including a preferred embodiment. These embodiments are described in sufficient detail to enable those of ordinary skill in the art to understand and implement the inventive subject matter. Other embodiments may be utilized and changes may be made without departing from the scope of the inventive subject matter. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

I claim:

1. An elongated masking tape strip comprising:
a flexible backing further comprising:
a first long side;
a second long side;
a third short side; and
a fourth short side; and
an adhesive placed on a portion of the flexible backing to form a first area including an adhesive and a second area that is adhesive free, the adhesive portion including at least one of the first long side and a second long side, the ratio of a third side to the first side being in the range of 1:18 to 1:192.

2. The elongated masking tape strip of claim 1, wherein the ratio of a third side to the first side being in the range of 1:20 to 1:150.

3. The elongated masking tape strip of claim 1, wherein the ratio of a third side to the first side being in the range of 1:25 to 1:101.

4. The elongated masking tape strip of claim 1, wherein the ratio of a third side to the first side being in the range of 1:30 to 1:84.

5. The elongated masking tape strip of claim 1, wherein the second area includes a first corner and a second corner on the other of the first long side and a second long side.

6. The elongated masking tape strip of claim 1, wherein the second area includes substantially the entire length the other of the first long side and a second long side.

7. The elongated masking tape strip of claim 1, wherein the flexible backing includes a visual indicator that indicates one of at least first area or the second area.

8. The elongated masking tape strip of claim 1, wherein the flexible backing includes a tactile indicator that indicates one of at least first area or the second area.

9. The elongated masking tape strip of claim 8, wherein the tactile indicator is a texture associated with one of at least first area or the second area.

10. The elongated masking tape strip of claim 1, wherein the first long side and the second long side are different lengths.

11. The elongated masking tape strip of claim 1, wherein the first long side and the second long side are substantially equal in length and wherein the third side and the fourth side are substantially equal in length, the first long side and the second long side having a length that is different from the length of the third side and the fourth side.

12. A dispensing apparatus for dispensing strips of masking material comprising:
a first tape strip; and
a second tape strip stacked onto the first tape strip, the first tape strip and the second tape strip further comprising:
a flexible backing further comprising:
a first long side;
a second long side;
a third short side; and
a fourth short side; and
an adhesive placed on a portion of the flexible backing to form a first area including an adhesive and a second area that is adhesive free, the adhesive portion including at least one of the first long side and a second long side, the ratio of a third side to the first side being in the range of 1:18 to 1:192.

13. The dispensing apparatus of claim 12, wherein the ratio of a third side to the first side being in the range of 1:20 to 1:150.

14. The dispensing apparatus of claim 12, wherein the ratio of a third side to the first side being in the range of 1:25 to 1:101.

15. The dispensing apparatus of claim 12, wherein the ratio of a third side to the first side being in the range of 1:30 to 1:84.

16. The dispensing apparatus of claim 12, wherein the first tape strip and the second tape strip are included in a stack of strips.

17. The dispensing apparatus of claim 16, wherein the stack of strips has a thickness in the range from 0.10 to 3.0 inches.

18. The dispensing apparatus of claim 16, wherein the stack of strips has a thickness in the range from 0.25 to 2.5 inches.

19. The dispensing apparatus of claim 16, wherein the stack of strips has a thickness in the range from 0.35 to 2.1 inches.

20. The dispensing apparatus of claim 16, wherein the stack of strips includes a stiffening member associated with the stack of strips.
